(19) United States
(12) Patent Application Publication
(10) Pub. No.: US 2011/0219910 A1
(43) Pub. Date: Sep. 15, 2011

(54) Grip Sleeve Assembly

(76) Inventor: Tieh-Han Wu, Tainan City (TW)

(21) Appl. No.: 12/722,960

(22) Filed: Mar. 12, 2010

(51) Int. Cl. B62D 1/06; G05G 1/10

(52) U.S. Cl. 74/558

(57) ABSTRACT

A grip sleeve assembly is adapted to be mounted on a grip portion of a steering wheel. The grip sleeve assembly includes an anti-slip sleeve, a resilient clamp, and a grip sleeve. The anti-slip sleeve is adapted to be sleeved on and in frictional contact with the grip portion, has a C-shaped cross-section, and is formed with a gap adapted for permitting the grip portion to be removed from the anti-slip sleeve therethrough. The resilient clamp has a C-shaped cross-section, and is mounted to the anti-slip sleeve to thereby bias the anti-slip sleeve to clamp the grip portion. The grip sleeve is mounted fixedly around the anti-slip sleeve.

### BACKGROUND OF THE INVENTION

1. Field of the Invention

This invention relates to a grip sleeve assembly, more particularly to a grip sleeve assembly for a grip portion of a steering wheel.

2. Description of the Related Art

Steering wheels for vehicles usually have single-color appearances. In order to improve the appearance of the steering wheel, users often mount two multiple-color grip sleeves on a steering wheel. However, a conventional grip sleeve is secured on a grip portion of the steering wheel by a double-sided adhesive tape disposed between the grip sleeve and the grip portion or by a rope wound around the grip sleeve. In the case of the double-sided adhesive tape, when the grip sleeve is detached from the steering wheel, the grip portion becomes sticky, thereby resulting in inconvenience during use of the steering wheel. In the case of the rope, the rope is easily loosened from the grip sleeve, which leads to undesired movement of the grip sleeve relative to the steering wheel, thus making it dangerous to use during driving.

### SUMMARY OF THE INVENTION

Therefore, the object of the present invention is to provide a grip sleeve assembly capable of alleviating the above drawbacks of the prior art.

Accordingly, a grip sleeve assembly of the present invention is adapted to be mounted on a grip portion of a steering wheel. The grip sleeve assembly comprises an anti-slip sleeve, a resilient clamp, and a grip sleeve. The anti-slip sleeve is adapted to be sleeved on and is in frictional contact with the grip portion. The anti-slip sleeve has a C-shaped cross-section, and is formed with a gap adapted for permitting the grip portion to be removed from the anti-slip sleeve therethrough. The resilient clamp has a C-shaped cross-section, and is mounted to the anti-slip sleeve to thereby bias the anti-slip sleeve to clamp the grip portion. The grip sleeve is mounted fixedly around the anti-slip sleeve.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of a first preferred embodiment of a grip sleeve assembly adapted to be mounted on a grip portion of a steering wheel;

FIG. 2 is an exploded perspective view of the first preferred embodiment;

FIG. 3 is a perspective view of an anti-slip sleeve and a resilient clamp of the first preferred embodiment, illustrating how the resilient clamp is mounted to the anti-slip sleeve;

FIG. 4 is a sectional view of the first preferred embodiment; and

FIG. 5 is an exploded perspective view of a second preferred embodiment of a grip sleeve assembly according to the present invention.

### DETAILED DESCRIPTION OF THE PREFERRED EMBODIMENTS

Before the present invention is described in greater detail, it should be noted that like reference numerals are used to indicate corresponding or analogous elements throughout the accompanying disclosure.

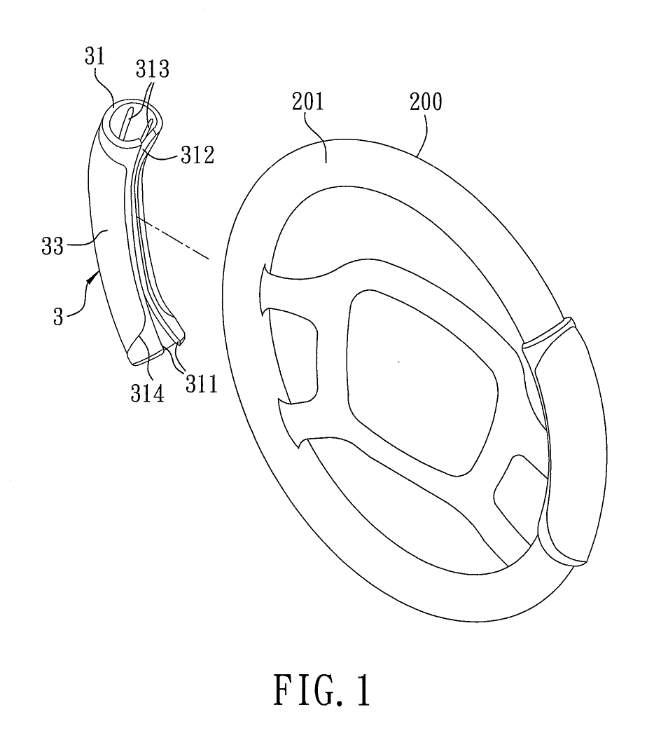

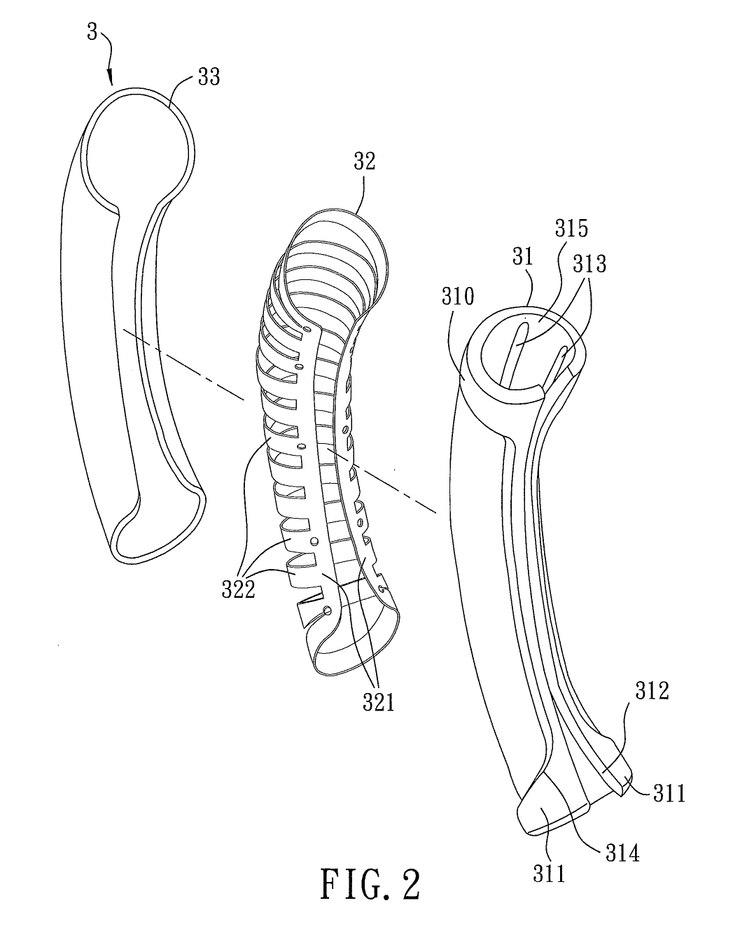

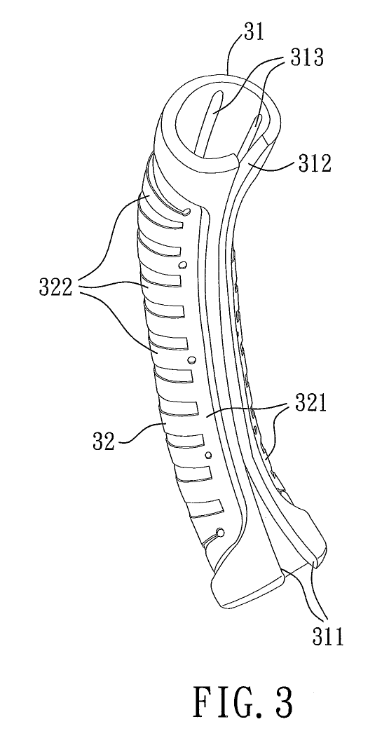

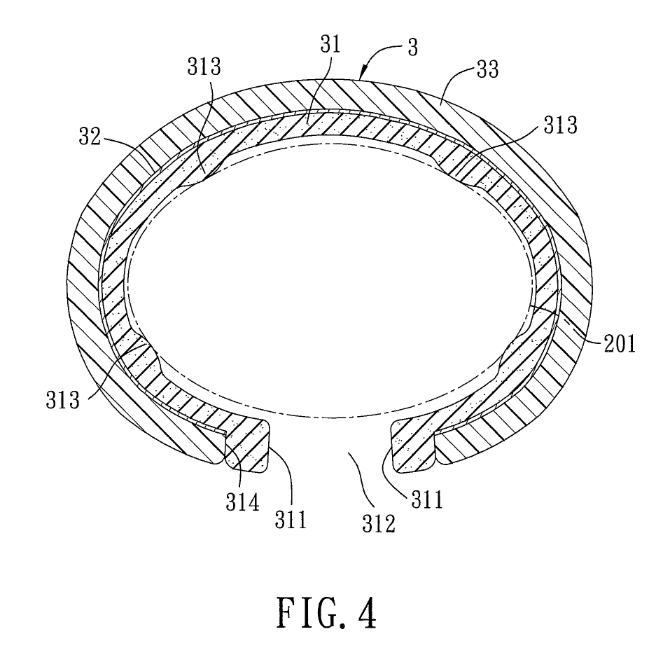

Referring to FIGS. 1 to 4, a first preferred embodiment of a grip sleeve assembly according to the present invention is shown. The grip sleeve assembly 3 is adapted to be mounted on a grip portion 201 of a steering wheel 200. The grip sleeve assembly 3 includes an anti-slip sleeve 31, a resilient clamp 32, and a grip sleeve 33.

The anti-slip sleeve 31 is adapted to be sleeved on and is in frictional contact with the grip portion 201, and has a C-shaped cross-section. The anti-slip sleeve 31 is formed with a gap 312 adapted for permitting the grip portion 201 to be removed from the anti-slip sleeve 31 therethrough and an indentation 314 in an outer peripheral surface 310 thereof. The anti-slip sleeve 31 includes two side edges 311 defining the gap 312 therebetween and a plurality of ribs 313 that are formed on an inner peripheral surface 315 thereof and that are adapted to abut against the grip portion 201 of the steering wheel 200.

The resilient clamp 32 has a C-shaped cross-section, and is mounted to the anti-slip sleeve 31 to thereby bias the anti-slip sleeve 31 to clamp the grip portion 201 of the steering wheel 200. The resilient clamp 32 is sleeved on the outer peripheral surface 310 of the anti-slip sleeve 31, such that the anti-slip sleeve 31 is clamped between the resilient clamp 32 and the grip portion 201. The resilient clamp 32 is elongated and has two elongated connecting strip portions 321 and a plurality of C-shaped clasping portions 322. The connecting strip portions 321 are respectively disposed along and adjacent respectively to the side edges 311 of the anti-slip sleeve 31 and extend along the longitudinal direction of the resilient clamp 32. The C-shaped clasping portions 322 are spaced apart from each other along the longitudinal direction and are connected integrally between the elongated connecting strip portions 321. The resilient clamp 32 is made of metal in this preferred embodiment. It should be noted that the resilient clamp 32 can be made of plastic in other preferred embodiments.

The grip sleeve 33 is mounted fixedly on the anti-slip sleeve 31 for covering the resilient clamp 32 on the anti-slip sleeve 31 and around the anti-slip sleeve 31. The resilient clamp 32 and the grip sleeve 33 are fitted fixedly within the indentation 314 of the anti-slip sleeve 31. In this preferred embodiment, the grip sleeve 33 is mounted fixedly on the anti-slip sleeve 31 by an adhesive.

When it is desired to mount the grip sleeve assembly 3 on the grip portion 201 of the steering wheel 200, the side edges 311 of the anti-slip sleeve 31 are first pulled apart against the biasing action of the resilient clamp 32 such that the dimension of the gap 312 is increased for permitting the grip portion 201 to be mounted into the anti-slip sleeve 31 through the gap 312. Next, the side edges 311 are released, so that the resilient member 32 biases the anti-slip sleeve 31 to clamp the grip portion 201 such that the ribs 313 of the anti-slip sleeve 31 abut against an outer peripheral surface of the grip portion 201. Therefore, the grip sleeve assembly 3 is mounted fixedly on the grip portion 201 of the steering wheel 200.

When it is desired to remove the grip sleeve assembly 3 from the grip portion 201, the side edges 311 of the anti-slip sleeve 31 are pulled away each other such that the dimension of the gap 312 is increased for permitting the grip portion 201 of the steering wheel 200 to be removed from the anti-slip sleeve 31 through the gap 312. Therefore, the grip sleeve assembly 3 can be reused.

It should be noted that, while the ribs 313 of the anti-slip sleeve 31 extend along the longitudinal direction in this preferred embodiment, they may extend along directions other than the longitudinal direction, and may be omitted in other preferred embodiments.

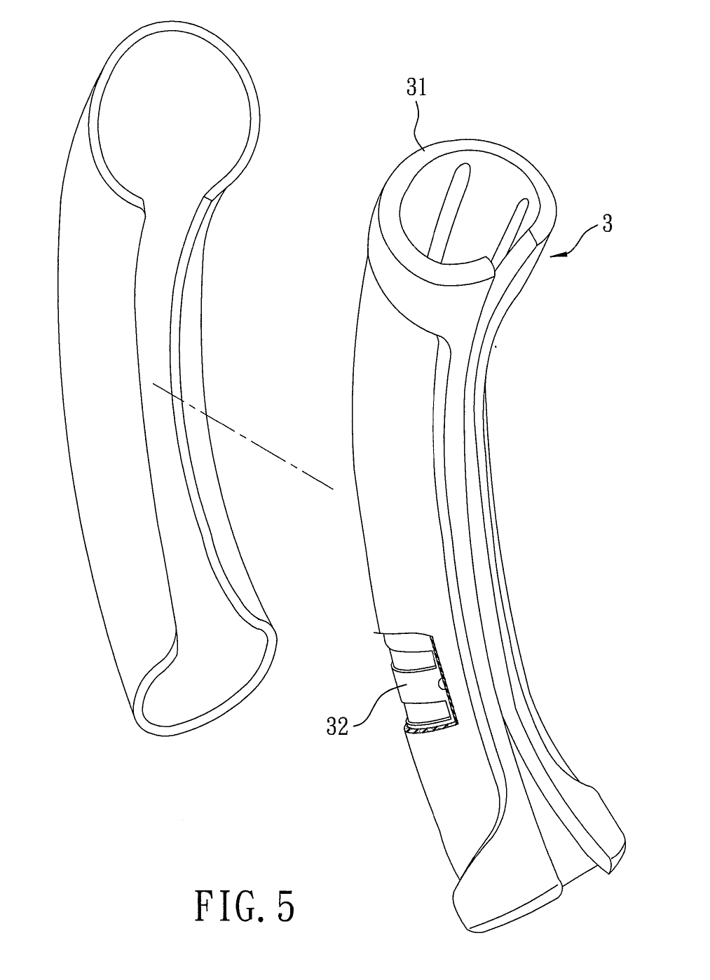

Referring to FIG. 5, a second preferred embodiment of the grip sleeve assembly 3 of the present invention is shown. The main difference between the second embodiment and the first embodiment resides in the following. The resilient clamp 32 is embedded in the anti-slip sleeve 31. In this embodiment, an anti-slip material is employed to cover the resilient clamp 32 and constitutes the anti-slip sleeve 31. Therefore, the anti-slip sleeve 31 is connected fixedly to the resilient clamp 32. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A grip sleeve assembly adapted to be mounted on a grip portion of a steering wheel, said grip sleeve assembly comprising:
an anti-slip sleeve adapted to be sleeved on and in frictional contact with the grip portion, having a C-shaped cross-section, and formed with a gap adapted for permitting the grip portion to be removed from said anti-slip sleeve therethrough;
a resilient clamp having a C-shaped cross-section, and mounted to said anti-slip sleeve to thereby bias said anti-slip sleeve to clamp the grip portion; and
a grip sleeve mounted fixedly around said anti-slip sleeve.

2. The grip sleeve assembly as claimed in claim 1, wherein said resilient clamp is embedded in said anti-slip sleeve.

3. The grip sleeve assembly as claimed in claim 1, wherein said resilient clamp is sleeved on an outer peripheral surface of said anti-slip sleeve, such that said anti-slip sleeve is clamped between said resilient clamp and the grip portion, said grip sleeve being mounted fixedly on said anti-slip sleeve for covering said resilient clamp on said anti-slip sleeve.

4. The grip sleeve assembly as claimed in claim 3, wherein said anti-slip sleeve is formed with an indentation in said outer peripheral surface thereof, said resilient clamp and said grip sleeve being fitted fixedly within said indentation of said anti-slip sleeve.

5. The steering wheel as claimed in claim 1, wherein said anti-slip sleeve includes two side edges defining said gap therebetween, said resilient clamp being elongated and having two elongated connecting strip portions that are disposed respectively along and adjacent respectively to said side edges of said anti-slip sleeve and that extend along a longitudinal direction of said resilient clamp, and a plurality of C-shaped clasping portions spaced apart from each other along the longitudinal direction and connected integrally between said elongated connecting strip portions.

6. The steering wheel as claimed in claim 5, wherein said anti-slip sleeve further includes a plurality of ribs formed on an inner peripheral surface of said anti-slip sleeve and adapted to abut against the grip portion.
